(19) United States
(12) Patent Application Publication
(10) Pub. No.: US 2010/0105581 A1
(43) Pub. Date: Apr. 29, 2010

(54) LUBRICATING OIL COMPOSITION CONTAINING IONIC LIQUID

(76) Inventors: Takanori Shiraishi, Ehime (JP); Katsushi Hirata, Ehime (JP)

Correspondence Address: WENDEROTH, LIND & PONACK L.L.P., 1030 15th Street, N.W., Suite 400 East, Washington, DC, 20005-1503, US

(21) Appl. No.: 12/605,549

(22) Filed: Oct. 26, 2009

(30) Foreign Application Priority Data
Oct. 28, 2008 (JP) 2008-277480

(51) Int. Cl. F16C 33/00; C10M 169/04; C10M 135/18

(52) U.S. Cl. 508/100; 508/110; 508/444

(57) ABSTRACT

The problem to be solved by the present invention is to provide an ionic liquid-containing lubricating oil composition that has extremely low viscosity and does not evaporate during use.

This problem is solved through the use of a lubricating oil composition that contains as a base oil an ionic liquid with a kinematic viscosity of 5-20 mm²/s at 40° C., and a polymerization inhibitor with a molecular weight of 200-600.

### CROSS REFERENCE TO RELATED APPLICATION

The disclosure of Japanese Patent Application No. 2008-277480 filed on Aug. 28, 2008 including the specification, drawings and abstract is incorporated herein by reference in its entirety.

### BACKGROUND OF THE INVENTION

1. Field of the Invention

The present invention relates to a lubricating oil composition that contains an ionic liquid.

2. Description of the Related Art

In recent years, associated with the miniaturization of hard disk drives and higher rotation speeds, there has been a demand for spindle motors with lower power consumption and longer operational lifetimes. For this reason, regarding the lubricating oil used in the hydrodynamic bearing with which the spindle motor is equipped, there is a demand for low viscosity and little evaporation during use. In particular, in hard disk drives, in addition to the problem of simply diminishing the lubricating oil, the evaporation of the lubricating oil can cause problems in which gases produced by the evaporation of the lubricating oil are adsorbed onto the hard disk and exert an effect on the sliding characteristics of the read/write head and on the error rate of the device. In response to the above-mentioned demand, to replace the ester oils widely used as the base oil for conventional lubricating oils, the use of ionic liquids has been proposed (for example, the below Patent Document 1).

[Patent document 1] Japanese Published Unexamined Patent Application No. 2007-2174

However, although not generally known, it has been clarified through the research of the present inventors that for ionic liquids with extremely low viscosity that are considered suitable for use in miniature hard disk drives, there is much evaporation during use.

Consequently, the present invention provides an ionic liquid lubricating oil composition that has extremely low viscosity and has little evaporation during use.

### SUMMARY OF THE INVENTION

From the results of diligently conducted research, the present inventors discovered unexpectedly that it is possible to suppress the evaporation of an ionic liquid in a lubricating oil composition by adding to the ionic liquid-containing lubricating oil composition a polymerization inhibitor of a specific molecular weight, and through the results of further studies achieved the completion of the present invention.

Specifically, the present invention provides:

[1]
a lubricating oil composition containing
an ionic liquid that has a kinematic viscosity of 5-20 mm²/s at 40° C. as a base oil, and
a polymerization inhibitor with a molecular weight of 200-600;
[2]
the lubricating oil composition stated in the abovementioned [1] wherein the aforementioned polymerization inhibitor is a dithiocarbamate compound;
[3]
the lubricating oil composition stated in the abovementioned [1] or [2] that contains 0.01-5 wt % of the aforementioned polymerization inhibitor;
[4]
the lubricating oil composition stated in any one of the abovementioned [1] to [3] of which the evaporation quantity after 120 hours is measured according to the JIS C2101 measurement method is ≦3 wt %.
[5]
a hydrodynamic bearing device that has a sleeve with a bearing bore, and has a shaft structure that is positioned in aforementioned bearing bore in a rotatable state relative to aforementioned sleeve, said hydrodynamic bearing device having the lubricating oil composition stated in any one of the abovementioned [1] to [4] maintained in the gap formed between aforementioned sleeve and aforementioned shaft structure; and,
[6]
a hard disk drive spindle motor that includes the hydrodynamic bearing device stated in the abovementioned [5].
and the like.

According to the present invention, an ionic liquid-containing lubricating oil composition that has extremely low viscosity and little evaporation loss during use is provided.

Moreover, an ionic liquid-containing lubricating oil composition of the present invention has the advantage that deterioration due to use is suppressed, the production of precipitates due to deterioration is also more difficult, and for this reason it is more difficult for motor lock to occur or for fluctuations in dynamic pressure to be produced.

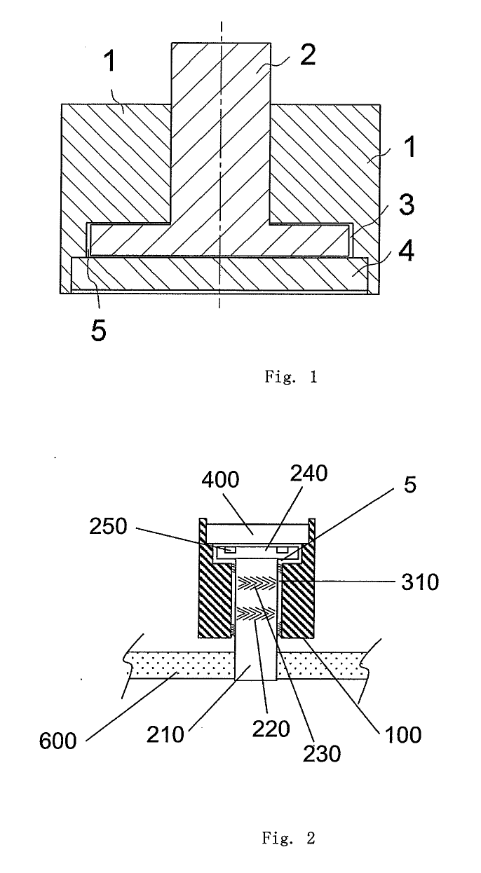

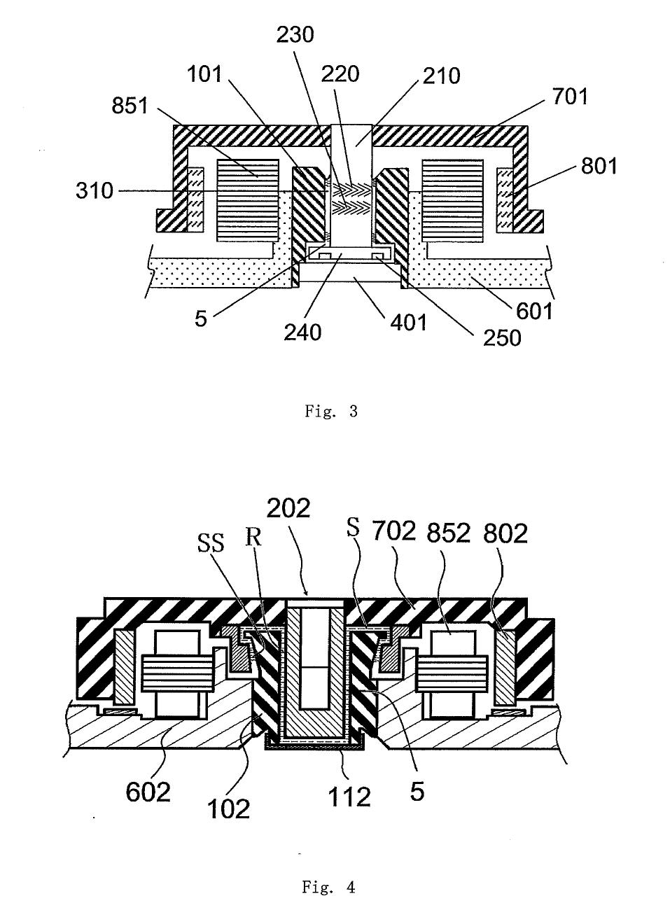

### BRIEF EXPLANATION OF DRAWINGS

[FIG. 1] is a cross-sectional diagram that shows the constitution of the main components of one embodiment of a hydrodynamic bearing device of the present invention.

[FIG. 2] is a cross-sectional diagram of the main components of a fixed shaft-type hydrodynamic bearing device of the present invention.

[FIG. 3] is a cross-sectional diagram of the main components of a magnetic disk device equipped with a spindle motor that has a rotating shaft-type hydrodynamic bearing device of the present invention.

[FIG. 4] is a cross-sectional diagram of the main components of a magnetic disk device equipped with a spindle motor that has a hydrodynamic bearing device of the present invention.

### DETAILED DESCRIPTION OF THE INVENTION

The present invention is explained below.

### [Lubricating Oil Composition]

A lubricating oil composition of the present invention contains an ionic liquid as the base oil. Ionic liquids are liquids at room temperature, are ionic substances constituted from cations and anions, and are also referred to as room temperature molten salts.

Said ionic liquid has a kinematic viscosity at 40° C. of 5-20 mm²/s, preferably 7-15 mm²/s, and more preferably 7-11 mm²/s.

In the present specification, “kinematic viscosity at 40° C.” is the numerical value measured for the ionic liquid at a temperature of 40° C. according to the method described in JIS K2283.

In the present specification, “oil” means a substance that is a liquid at normal temperatures (20° C. to 35° C.).

In the present specification, “base oil” means a substance that is the main component of a lubricating oil composition and that imparts lubricant properties thereto. Consequently, the amount of the base oil contained in the lubricating oil composition is ≧50 wt % based on the entire lubricating oil composition.

There is no particular limitation to the ionic liquid used in the present invention if it has the abovementioned kinematic viscosity, but examples of ionic liquids that can be named have cations such as imidazolium ion, pyrazolium ion, pyrrolidinium ion, pyridinium ion, piperidinium ion, phosphonium ion, sulfonium ion and ammonium ion.

Among these, imidazolium ionic liquids represented by Formula (I)

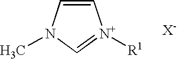

[where in the formula,
R¹ represents a lower alkyl group, and
X⁻ represents an anion] are preferred.
Examples of the lower alkyl group represented by R¹ include alkyl groups with a carbon number of 1-4 such as methyl, ethyl, n-propyl, isopropyl, n-butyl, sec-butyl and tert-butyl and the like. Among these, ethyl is preferred.

Examples of the anion represented by X⁻ include Cl⁻, Br⁻, I⁻, BF₄⁻, PF₆⁻, [SCN]⁻, [CₙF₂ₙ₊₁SO₃]⁻, [(CₙF₂ₙ₊₁SO₂)₂N]⁻, [p-CH₃C₆H₄SO₂]⁻, [CₙH₂ₙ₊₁SO₃]⁻, [CₙH₂ₙ₊₁OSO₃]⁻, [CₙH₂ₙ₊₁CO₂]⁻, [CₙF₂ₙ₊₁CO₂]⁻, [N(CN)₂]⁻, [C(CN)₃]⁻ and [(CₙH₂ₙ₊₁)₂PO₄]⁻. Among these, BF₄⁻, [(CF₃SO₂)₂N]⁻, [N(CN)₂]⁻ and [C(CN)₃]⁻ are preferred. Here, n is an integer from 1 to 8.

Examples of the imidazolium ionic liquid represented by Formula I that are particularly preferred are:
1-ethyl-3-methylimidazolium tetrafluoroborate,
1-ethyl-3-methylimidazolium bis(trifluoromethanesulfonyl)imide,
1-ethyl-3-methylimidazolium dicyanamide, and
1-ethyl-3-methylimidazolium tricyanomethane,

Such ionic liquids can be used individually as one type or as combinations of two or more types.

The lower limit for the ionic liquid content in the lubricating oil mixture of the present invention is preferably 90 wt %, more preferably 95 wt %, furthermore preferably 98 wt % and particularly preferably 99 wt %.

Ionic liquids used in the present invention that have a melting point ≦0° C. are preferred. Among these, ionic liquids that have a melting point from 0 to −60° C. are more preferred. The melting point is measured using differential scanning calorimeter (DSC). When a lubricating oil composition of the present invention is used in a hydrodynamic bearing device, an ionic liquid with a melting point and freezing point near to room temperature will markedly increase the torque of the bearing in a low temperature environment, and there is also a high probability that bearing lock will occur, so that sufficient reliability will not be obtained.

Moreover, the volume resistivity measured at 20° C. and 5 V according to JIS C2101 will preferably be ≦10⁹ Ω·cm, more preferably ≦10⁸ Ω·cm, furthermore preferably ≦10⁷ Ω·cm, and particularly preferably ≦10⁶ Ω·cm. When the lubricating oil composition is used in a hydrodynamic bearing device, since static electricity is generated from friction between the air and the sides of the shaft or the sleeve during rotation, this can be the cause of an equipment malfunction. However, if the volume resistivity is ≦10⁹ Ω·cm, the static charge generated by the rotating components passes through the ionic liquid, and flows to some extent to the fixed side of the bearing device. For this reason, a hydrodynamic bearing device that uses the lubricating oil composition of the present invention does not need to be equipped with a component for the purpose of alleviating the static charge.

Moreover, a lubricating oil composition of the present invention contains a polymerization inhibitor with a molecular weight of 200-600.

A molecular weight of <200 is not preferred from the perspective that the polymerization inhibitor itself will have insufficient heat resistance. Moreover, a molecular weight that exceeds 600 is not preferred, since the polymerization inhibitor will be difficulty soluble in the ionic liquid, and it will not be possible to add a sufficient quantity from the perspective that it will precipitate readily at low temperature.

As said polymerization inhibitor, compounds normally used for the purpose of inhibiting the radical polymerization of the polymerizable compounds in resin or rubber or the like, or compounds normally used for the purpose of controlling the degree of polymerization in polymer synthesis can be used. Examples of such compounds that can be named include quinone compounds, phenolic compounds, sulfide compounds and the like, and sulfide compounds are preferred. Among these, dithiocarbamate compounds that are one type of sulfide compound represented by the formula

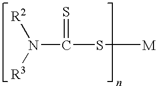

[where in the formula
R² and R³ indicate respectively lower alkyl groups,
M indicates a bond or a metal element,
and n indicates 1 or 2.] is more preferred.

Examples of the lower alkyl group represented by R² and R³ are the same as those examples indicated for the lower alkyl group represented by R¹.

Examples of the metal element represented by M that can be named include metal elements in the monovalent or divalent state such as sodium, manganese, copper, iron, cobalt, nickel, zinc, selenium and tellurium. Among these, the divalent metal elements are preferred.

n is preferably 2.

As a dithiocarbamate compound in which M is a metal element, particularly preferred is copper dibutyldithiocarbamate.

Additionally, as a dithiocarbamate compound in which M is a bond, particularly preferred is tetraethylthiuram disulfide.

The content of the abovementioned polymerization inhibitor in the lubricating oil composition of the present invention is preferably 0.01-5 wt %, more preferably 0.1-2 wt %, and furthermore preferably 0.5-1 wt %. In addition, two or more type of such polymerization inhibitors can be combined.

Moreover, the lubricating oil composition of the present invention can optionally contain additives. Examples of such additives that can be named include antioxidants, rust-inhibitors, metal deactivators, metal corrosion inhibitors, oiliness improvers, extreme pressure agents, friction modifiers, anti-wear agents, viscosity index improves, pour point depressants, antifoaming agents, hydrolysis inhibitors, antistatic agents, conductivity-enhancing agents, detergent-dispersants and the like.

For the lubricating oil composition of the present invention, it is preferable to add the minimum required amount of the abovementioned additives. Specifically, the content of the abovementioned additives is normally ≦5 wt %, preferably 2≦wt %, based on the entire lubricating oil composition.

The lubricating oil composition of the present invention can be constituted from the abovementioned ionic liquid, the abovementioned polymerization inhibitor and optionally the abovementioned additives through mixing by any conventional method.

For the lubricating oil composition of the present invention, the evaporation quantity is extremely low, and the evaporation quantity after 120 hours as measured according to the JIS C2101 measurement method is ≦3 wt %, preferably ≦2 wt %.

Furthermore, the blending quantities of additives shown in the present invention, in other words the wt % s, are the percentages based on the lubricating oil composition that includes the base oil and the additives (total weight).

Moreover, the lubricating oil composition of the present invention has superior heat resistance, and superior properties such as not readily producing precipitates nor increasing viscosity under heating.

For this reason, the lubricating oil composition of the present invention can be suitable for use in a hydrodynamic bearing in a hard disk drive spindle motor even with the requirements of frictional heat generation and longer operational lifetimes.

### [Hydrodynamic Bearing Device]

A hydrodynamic bearing device that uses a lubricating oil composition of the present invention is also one mode of the present invention.

For the purpose of explaining an overview of the hydrodynamic bearing device of the present invention, one mode thereof is shown in FIG. 1, but the present invention is not limited thereto.

Said hydrodynamic bearing device has sleeve 1 that has a bearing bore, and shaft structure 2 that is positioned in a rotatable state relative to aforementioned sleeve 1 within aforementioned bearing bore, and lubricating oil composition 5 of the present invention is maintained in gap 3 formed between aforementioned sleeve 1 and aforementioned shaft structure 2.

An embodiment is shown in detail below according to a mode for embodying the present invention, and is described together with the diagrams.

### Embodiment 1

Embodiment 1 of the present invention is explained by using FIG. 2. FIG. 2 is a cross-sectional diagram of the main components of a fixed shaft type hydrodynamic bearing device in Embodiment 1.

In FIG. 2, radial dynamic pressure-generating grooves 220, 230 are formed on the outer peripheral surface of shaft 210. One end of shaft 210 is fixed to thrust flange 240 and the other end is press-fitted and fixed to base 600. Shaft 210 and thrust flange 240 constitute a shaft structure. The shaft structure and base 600 constitute a fixed portion.

At the same time, sleeve 100 has a bearing bore that supports the shaft structure. Thrust plate 400 is mounted on one end of sleeve 100. The shaft structure is inserted into the bearing bore of sleeve 100 so that thrust plate 400 and thrust flange 240 face each other. Sleeve 100 and thrust plate 400 constitute a rotator. In addition, thrust dynamic pressure-generating groove 250 is formed at the facing surfaces of thrust flange 240 and thrust plate 400. Lubricating oil composition of the present invention 5 is interposed into the gap between the bearing bore and the shaft structure. A motor drive portion is formed by the rotator and the fixed portion.

Accompanying the rotation of the rotator, lubricating oil composition 5 is gathered up in dynamic pressure-generating grooves 220, 230, which produce pumping pressure in the radial direction in radial gap 310 between shaft 210 and sleeve 100. In the same manner, due to the rotation, lubricating oil composition 5 is gathered up in dynamic pressure-generating groove 250, which generates pumping pressure in the thrust direction between thrust flange 240 and thrust plate 400. In this way, the rotator is floated with respect to the fixed portion and is rotatably supported without contact.

Furthermore, as mentioned in the explanation above, radial dynamic pressure-generating grooves are formed on the outer peripheral surface of shaft 210, but they can also be formed on the bearing bore surface of sleeve 100 (inner peripheral surface), as well as on both the outer peripheral surface of shaft 210 and the bearing bore surface of sleeve 100. In other words, at least one of the shaft and the sleeve can have radial dynamic pressure-generating mechanical features. Additionally, radial dynamic pressure-generating mechanical features can be present between the lateral surface of thrust flange 240 and sleeve 100. Examples of dynamic pressure-generating mechanical features that can be named include various types of shapes such as grooves, projections, bumps, inclined planes and the like. Moreover, radial dynamic pressure-generating grooves can adopt various types of shapes such as a herringbone shape, a spiral shape and the like (in the diagram, radial dynamic pressure-generating grooves with a herringbone shape are shown).

In addition, thrust dynamic pressure-generating grooves can be formed either only on the face of thrust plate 400 opposite to thrust flange 240, or only the face of thrust flange 240 opposite to thrust plate 400, or only the reverse side of the face of thrust flange 240 opposite to thrust plate 400, as well as on 2 or more of the aforementioned 3 locations.

Furthermore, for any dynamic pressure-generating mechanical features similar to those mentioned above in addition to thrust dynamic pressure-generating grooves, any type of mechanical feature will be satisfactory.

In the present embodiment, one end of the hydrodynamic bearing is fixed, but there is no limitation [to this configuration], and the same effect can be obtained with both ends being fixed or with both ends of the bearing bore of the sleeve being open.

### Embodiment 2

Embodiment 2 of the present invention is explained by using FIG. 3. FIG. 3 is a cross-sectional diagram of the main components of a magnetic disk device of Embodiment 2, equipped with a spindle motor that has a rotating shaft-type hydrodynamic bearing device. The hydrodynamic bearing device in the present embodiment differs from the hydrodynamic bearing device of Embodiment 1 in FIG. 2 from the perspective of adopting a rotating shaft system that replaces the fixed shaft. Other than this point, the constitution is the same as in Embodiment 1. Furthermore, components that have the same symbols are omitted in the detailed explanation.

In FIG. 3, radial dynamic pressure-generating grooves 220, 230 are formed in the outer peripheral surface of shaft 210, one end of which is fixed to thrust flange 240 and the other end of which is pressure-fitted into hub 701 for mounting a magnetic disk. Shaft 210 and thrust flange 240 form the shaft structure. Moreover, rotor magnet 801 is fixed to the inner peripheral surface of hub 701. The shaft structure (shaft 210 and thrust flange 240), hub 701 and rotor magnet 801 constitute the rotator. Furthermore, in the present invention, the shaft structure can be constituted from shaft 210 alone, or the shaft structure can be constituted from shaft 210 and thrust flange 240 as desired.

At the same time, sleeve 101 that is pressure-fitted into base 601 has a bearing bore that supports the shaft structure. Thrust plate 401 is mounted on one end of sleeve 101. The shaft structure is inserted into the bearing bore of sleeve 101 so that thrust plate 401 and thrust flange 240 face each other. Stator coil 851 is mounted on a wall formed by base 601. Base 601, sleeve 101, thrust plate 401 and stator coil 851 form the fixed portion. Thrust dynamic pressure-generating groove 250 is formed at the facing surfaces of thrust flange 240 and thrust plate 401. The bearing device is constituted when lubricating oil composition 5 is filled into the gap between the bearing bore and the shaft structure. The rotator and the fixed portion constitute the motor drive component.

The rotational driving action of the rotator due to this motor drive component will be explained.

First, stator coil 851 is energized to produce a rotating magnetic field, and rotor magnet 801 that is mounted to face stator coil 851 experiences rotational force and hub 701, shaft 210 and thrust flange 240 begin to rotate together. Due to this rotation, herringbone-shaped dynamic pressure-generating grooves 220, 230 and 250 gather up lubricating oil composition 5, and pumping pressure is generated in the radial direction together with in the thrust direction (between shaft 210 and sleeve 101, and between thrust flange 240 and thrust plate 401). As a result, the rotator is floated upwards with respect to the fixed portion and is rotatably supported without contact, and recording and reproduction of data on the magnetic disk is possible.

Furthermore, there is no limitation to the material of the magnetic disk mounted on hub 701, but, for example, it can be glass or aluminum. There is no limitation to the number of said magnetic disks, but, for example, when it is a miniature model, it is ≧1 disk (normally 1-2 disks). A lubricating oil composition and a hydrodynamic bearing device that is maintained by said lubricating oil composition of the present invention are particularly effective in magnetic disk devices and spindle motors equipped with small-scale magnetic disks ≦2.5 inches in size.

### Embodiment 3

FIG. 4 is a cross-sectional diagram of the main components of a magnetic disk device equipped with a spindle motor that has a rotating shaft-type hydrodynamic bearing device of Embodiment 3.

In this magnetic disk device, sleeve 102 that has a bearing bore that supports shaft structure 202 is pressure-fitted into the center of base 602, and stator coil 852 is mounted on a wall formed on base 602. Shaft structure 202 is inserted from one lateral end into the bearing bore of sleeve 102 and the other end is blocked by cap 112. Radial dynamic pressure-generating grooves (not shown in the figure) are formed on the outer peripheral surface of shaft structure 202, and one of its ends is pressure-fitted into hub 702 while the other end faces cap 112. The outer peripheral surface (dynamic pressure surface) of shaft structure 202 is in opposition across gap R in the radial direction with respect to the inner peripheral surface (dynamic pressure surface) of sleeve 102, and this gap R is filled with lubricating oil composition 5. Rotor magnet 802 is fixed to the inner peripheral surface of hub 702.

Additionally, the top end surface (dynamic pressure surface) of sleeve 102 and the bottom end surface (dynamic pressure surface) in the interior side of hub 702 are positioned to face each other passing through gap S in the axial direction, and thrust dynamic pressure-generating grooves (not shown in the figure) are formed on at least one side of these surfaces. For filling also gap S, lubricating oil composition 5 is filled from abovementioned gap R through to gap S in a substantially connected and uninterrupted fashion.

When shaft structure 202 and hub 702 are rotating, dynamic pressure is generated in lubricating oil composition 5 due to the action of the abovementioned thrust dynamic pressure-generating grooves. Due to this dynamic pressure, shaft structure 202 and hub 702 are floated up in the thrust direction and are rotatably supported without contact.

The outer peripheral side of sleeve 102 forms seal portion SS. The gap of seal portion SS is connected to gap S along the radial outward direction of sleeve 102. Consequently, seal portion SS prevents the outflow of lubricating oil composition 5.

Furthermore, in the abovementioned embodiment, motor rotational speeds of 3,600 rpm, 4,200 rpm, 5,400 rpm, 7,200 rpm, 10,000 rpm, 15,000 rpm or the like are used.

For the material of the shaft, stainless steel is the most suitable. Stainless steel has high hardness compared to other metals, and is effective because wear products are suppressed. More preferable is martensitic stainless steel.

For the sleeve, the use of a material such as copper alloy, iron alloy, stainless steel, aluminum alloy, ceramic, or resin is preferred. In addition, copper alloy, iron alloy or stainless steel are further preferred for greater wear resistance and higher workability, as well having a lower cost. Moreover, sintered materials are also satisfactory from the cost perspective, and the same effect can be obtained when a dynamic pressure-generating liquid is impregnated into a sintered material. All or part of the surface of the shaft material and/or the sleeve material can be subjected to a surface modification treatment such as plating, physical vapor deposition, chemical vapor deposition, diffusion coating or the like.

### EXAMPLES

The present invention is explained in detail in the working examples set forth below, but the present invention is not limited in any way to the working examples. Moreover, the characteristics of the lubricating oil in each of the working examples and comparative examples were evaluated using the methods below. (a) Kinematic viscosity was measured as the initial kinematic viscosity at 40° C. according to the measurement method of JIS K2283.

(b) Heat resistance was determined by measuring the evaporation quantity after 120 hours according to the measurement method JIS C2101, along with visual determination from the presence or absence of precipitates (ppt).

### Working Example 1

0.5 wt % of tetraethylthiuram disulfide (Sanshin Chemical Industry: Sanceler TET-G/molecular weight: 297) was blended into 1-ethyl-3-methylimidazolium dicyanamide (EMI•DCA) as the lubricating oil composition.

### Working Example 2

0.5 wt % of copper dibutyldithiocarbamate (Kawaguchi Chemical Industry: CB-W/molecular weight: 472) was blended into 1-ethyl-3-methylimidazolium dicyanamide (EMI•DCA) as the lubricating oil composition.

### Comparative Example 1

0.5 wt % of hydroquinone (Kawaguchi Chemical Industry: hydroquinone/molecular weight: 110) was blended into 1-ethyl-3-methylimidazolium dicyanamide (EMI•DCA) as the lubricating oil composition.

### Comparative Example 2

0.5 wt % of dimethylammonium dimethyldithiocarbamate (Sanshin Chemical Industry: Sanceler DAD/molecular weight: 166) was blended into 1-ethyl-3-methylimidazolium dicyanamide (EMI•DCA) as the lubricating oil composition.

### Comparative Example 3

1-ethyl-3-methylimidazolium dicyanamide (EMI•DCA) was the lubricating oil composition.

TABLE 1

| | | | | Kinematic | Heat resistance | |
|---|---|---|---|---|---|---|
| | | Polymerization inhibitor | | viscosity | Evaporation | |
| | | | Mol. | 40° C. | quantity | Ppt |
| | Ionic liquid | Name | weight | [mm²/s] | [wt %] | generated |
| Working | EMI•DCA | TET-G | 297 | 8.9 | 1.9 | none |
| Example 1 | | | | | | |
| Working | EMI•DCA | CB-W | 472 | 9.0 | 2.0 | none |
| Example 2 | | | | | | |
| Comparative | EMI•DCA | Hydroquinone | 110 | 8.8 | 10.1 | present |
| example 1 | | | | | | |
| Comparative | EMI•DCA | DAD | 166 | 8.8 | 5.0 | present |
| example 2 | | | | | | |
| Comparative | EMI•DCA | None blended | — | 8.7 | 4.0 | present |
| example 3 | | | | | | |

As shown through Table 1, in Comparative Examples 1-3, after testing for heat resistance, the evaporation quantity was shown to be ≧4 wt %, and precipitates not originally observed were confirmed to be present. On the other hand, in Working Examples 1-2, the evaporation effect was suppressed, and no precipitates due to deterioration were generated. From the above, the lubricating oil composition of the present invention is known to have superior heat resistance.

### INDUSTRIAL APPLICABILITY

The ionic liquid-containing lubricating oil compositions of the present invention are extremely low in viscosity, the evaporation loss of the ionic liquid due to deterioration during use is suppressed, and it can be used in the hydrodynamic bearing devices in hard disk drive spindle motors and the like.

1. A lubricating oil composition comprising as a base oil an ionic liquid that has a kinematic viscosity of 5-20 mm²/s at 40° C., and a polymerization inhibitor with a molecular weight of 200-600.

2. The lubricating oil composition according to claim 1 wherein said polymerization inhibitor is a dithiocarbamate compound.

3. The lubricating oil composition according to claim 1 which contains 0.01-5 wt % of the polymerization inhibitor.

4. The lubricating oil composition according to claim 1 of which the evaporation quantity after 120 hours is ≦3 wt %, as measured according to the JIS C2101 measurement method.

5. A hydrodynamic bearing device wherein the hydrodynamic bearing device has a sleeve that has a bearing bore, and has a shaft structure that is positioned in aforementioned bearing bore in a rotatable state relative to aforementioned sleeve, and the lubricating oil composition according to claim 1 is maintained in the gap formed between aforementioned sleeve and aforementioned shaft structure.

6. A hard disk drive spindle motor that includes the hydrodynamic bearing device according to claim 5.

7. A hydrodynamic bearing device wherein the hydrodynamic bearing device has a sleeve that has a bearing bore, and has a shaft structure that is positioned in aforementioned bearing bore in a rotatable state relative to aforementioned sleeve, and the lubricating oil composition according to claim 2 is maintained in the gap formed between aforementioned sleeve and aforementioned shaft structure.

8. A hydrodynamic bearing device wherein the hydrodynamic bearing device has a sleeve that has a bearing bore, and has a shaft structure that is positioned in aforementioned bearing bore in a rotatable state relative to aforementioned sleeve, and the lubricating oil composition according to claim 3 is maintained in the gap formed between aforementioned sleeve and aforementioned shaft structure.

9. A hydrodynamic bearing device wherein the hydrodynamic bearing device has a sleeve that has a bearing bore, and has a shaft structure that is positioned in aforementioned bearing bore in a rotatable state relative to aforementioned sleeve, and the lubricating oil composition according to claim 4 is maintained in the gap formed between aforementioned sleeve and aforementioned shaft structure.
